(19) United States
(12) Patent Application Publication
(10) Pub. No.: US 2002/0171931 A1
(43) Pub. Date: Nov. 21, 2002

(54) Integrated optical device with polarization based signal routing

(76) Inventors: Robert W. McLeod, Morgan Hill, CA (US); Alice Liu, Mountain View, CA (US); Tokuyuki Honda, Mountain View, CA (US)

Correspondence Address: LACASSE & ASSOCIATES, LLC, 1725 DUKE STREET, SUITE 650, ALEXANDRIA, VA, 22314, US

(21) Appl. No.: 09/808,107

(22) Filed: Mar. 15, 2001

(51) Int. Cl. G02B 5/30

(52) U.S. Cl. 359/484; 359/495; 359/496; 359/497

(57) ABSTRACT

An integrated WDM device is provided by replacing fiber routing with a birefringent routing element, e.g. a rutile crystal. The device has a routing block for directing an incoming polarized light beam launched into its input port in one of two directions in dependence upon the polarization state of the light beam. A plurality of thin film filter (TFF) elements is provided in a zig-zag pattern on both faces of the routing block for filtering specific wavelengths of the beam. A rotator is provided for rotating the polarization of a portion of the beam so that it follows a separate path after reflection from the optical filter element, the path corresponding to the zig-zag arrangement of the TFF elements. If the incoming beam is non-polarized, polarization diversity elements are disposed in the optical path of the beam to control the polarization. The device may function as a WDM or as an add/drop multiplexer/demultiplexer.

### FIELD OF THE INVENTION

The present invention relates to optical devices for signal routing, particularly to wavelength division multiplexing (WDM) devices, more particularly to such devices employing thin film filters (TFFs).

### BACKGROUND OF THE INVENTION

Wavelength division multiplexing (WDM) allows multiple different wavelengths to be carried over a common fiber optic waveguide. In performing WDM, the number of WDM channels is set from a wide range of several channels to about 100 channels depending upon systems. Further, a wide range of wavelength spacing of 1 μm or less to tens of nm is required. In applying WDM to a subscriber system, it is required to provide components at low prices. Accordingly, in WDM, a WDM filter usable as an optical multiplexer and/or an optical demultiplexer is a key device.

In another aspect, the application of WDM has been tried also in the field of measurement, and a WDM filter is an important component also in this field.

A conventional WDM filter device usable in an optical multiplexer/demultiplexer system is shown in FIG. 1. While the optical fiber-based device is useful, it has several disadvantages including relatively high labor and associated cost, as well as relatively large size. It is desirable to eliminate at least some of these drawbacks and afford lower loss, smaller size and greater ease of manufacturing compared to the fiber-based WDM systems.

It is also known that a TFF array can be interconnected in free space rather than over optical fibers. In a free-space interconnect, the light beams are directed so as to reflect from the TFFs at a greatest possible angle (from the normal incidence) in order to minimize the separation between filter planes. As the angle of incidence is increased, the polarization dependence and angular sensitivity of the filters increases. This results in a degraded performance and diminished tolerance to motion. Also, free space commonly means air whose refractive index n is around 1. As a result, the effective optical path length, d/n (where d is the actual path length of the light beam) is maximized. Since this quantity is limited by lens technology, the number of filters that can be packaged in a single component is severely limited.

U.S. Pat. No. 5,859,717 issued January 1999 to Scobey et al. proposes an optical multiplexing device having a precision optical block defining an optical gap between two parallel surfaces. A plurality of filters is secured to the parallel surfaces at input/output ports in a zig-zag pattern. Multi-channel collimated light beam enters the optical gap and follows the zig-zag pattern, wherein channels are removed or added through the ports.

As mentioned above, WDM thin film filters exhibit high wavelength sensitivity as a function of the angle of incidence, particularly at higher angles, starting at about 5-6°. For optimal performance and ease of fabrication, TFF modules should be designed for near-normal incidence, denoted as 0°, practically within +/−3° from normal incidence to minimize polarization dependence of the filter transmission. On the other hand, in order to physically separate the incident and reflected beams via free-space propagation, the length of the WDM package must exceed the filter width divided by the tangent of the angle of incidence on the filters. For a typical filter size (width) of ˜1.5 mm, this length is nearly 30 mm. Given the current technical limitation on the maximum distance between filter collimators of ˜100 mm, this limits the maximum number of filters in the free-space beam path to 3 or 4.

It is desirable to reduce the effective propagation distance between TFF modules and also the size of the entire package while the filters are positioned for as close as practical to normal incidence for optimal performance. It is also desirable to eliminate the above-discussed disadvantages of fiber-based WDM systems.

### SUMMARY OF THE INVENTION

In accordance with one aspect of the present invention, there is provided an optical filtering device comprising:

a routing block having an input port, for directing a polarized light beam launched into the input port in one of two directions in dependence upon the polarization state of the polarized light beam,

an optical filter element for filtering a characteristic of the beam, the filter being optically coupled with the routing block for allowing a first portion of the polarized beam to pass therethrough and for reflecting a second portion of the beam back to the routing block to follow a second path, and

a rotator for rotating the polarization of the second portion of the beam so that it follows the second path after reflection from the optical filter element.

The routing block may be exemplified by a block of birefringent material or by a polarization beam splitter (or an array of beam splitters).

The optical filter element is a wavelength dependent filter element for passing at least one wavelength of light and for reflecting a different wavelength of light. The filter element may for example be a dichroic filter.

Preferably, a plurality of optical filter elements is arranged at or about end face or faces of the routing block in a manner to define a zig-zag path for the polarized input beam when reflected from the plurality of the optical filter elements. The zig-zag path is preferably uniform, for the ease of manufacture and other reasons, thus the reflection angles are substantially identical.

The above aspect of the invention is directed at routing a polarized beam of light. In another aspect of the invention, aimed at filtering an incoming non-polarized beam, the optical filter further comprises a polarization diversity means for converting the non-polarized beam of light into one or two polarized beams of light. For example, a polarization diversity block, exemplified by a birefringent crystal (rutile crystal) or a polarizing beam splitter (PBS) may be provided for splitting the incoming beam into two orthogonally polarized sub-beams and for rotating the polarization state of at least one of the polarized sub-beams to form two sub-beams having a same polarization orientation.

In accordance with another aspect of the invention, there is provided a method of routing a polarized optical signal beam comprising

launching the polarized optical signal beam into a birefringent block having a first end face and a second end face,

reflecting the signal beam alternatively at the first and the second end face to effect a plurality of reflections,

rotating the polarization of the signal beam at least at some of the reflections to effect an angular displacement of the signal beam in the birefringent block upon reflection of the beam,

whereby the signal beam is routed along a zig-zag path through the birefringent block.

The reflecting and rotating is not necessarily simultaneous and can be spatially separated. The reflecting can be effected using at least one reflective surface at one of the end faces of the birefringent block. Alternatively, the reflecting can be effected using a plurality of reflective filters arranged at the first and second end face of the birefringent block. In an embodiment of the invention, the reflective filters may be thin film filters selected to filter predetermined channels out of the multi-channel optical signal beam.

### BRIEF DESCRIPTION OF THE DRAWINGS

In the drawings

FIG. 1 is a schematic representation of a prior art three-port TFF optical device with fiber interconnections,

FIG. 2 is a top view of a 4-channel WDM device of the invention, operable with a polarized incoming light beam

FIG. 3 is a top view of a 4-channel WDM device of the invention, operable with a non-polarized incoming light beam,

FIG. 4 is a side view of the device of FIG. 3,

FIG. 5 is a partial schematic representation of an embodiment of the invention using PBS as polarization diversity means,

FIG. 6 is a schematic representation of another embodiment of the invention,

FIG. 7 is a more detailed representation of the embodiment of FIG. 5,

FIG. 8 is a top view of an embodiment using HWPs and Faraday rotators, and,

FIG. 9 is a side view of the embodiment of FIG. 8.

### DETAILED DESCRIPTION OF THE INVENTION

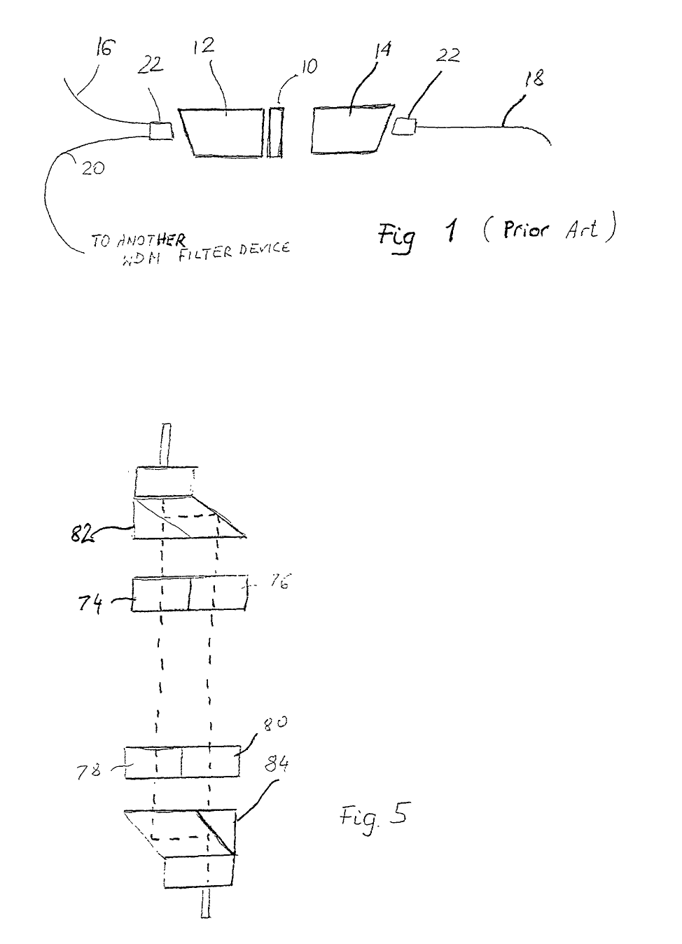

FIG. 1 represents a prior art WDM filter device. For clarity, the elements are represented separately. The three-port device has a single TFF 10 and two graded index (GRIN) lenses 12, 14. A common input signal is supplied through an optical fiber 16 and launched onto the filter 10 whereby it becomes partly reflected and partly transmitted. Fiber 18 carries the pass signal while the reflected signal is passed through fiber 20 to another WDM device. Standard ferrules 22 are provided for mounting and alignment of the fibers 16, 18 and 20. The number of the devices in the system can be significant depending on the channel selection.

It is understood that a TFF is required for each wavelength to be dropped or added, and the packaged TFF filters are cascaded through fiber connections to create a WDM module. Typical specifications for such modules, dependent on the channel count, are given in Table 1.

TABLE 1
Typical specifications for thin film filter WDM

| | | | |
|---|---|---|---|
| Channel Count | | 8 | 16 |
| Channel Spacing | (GHz) | 100 | 100 |
| Insertion Loss | (dB) | 4 | 6 |
| Insertion Loss Uniformity | (dB) | 1.5 | 2 |
| Adj. Channel Crosstalk | (dB) | −25 | −25 |
| Non-adj. Channel Crosstalk | (dB) | −40 | −40 |
| Passband Ripple | (dB) | 1 | 1 |
| PDL (polariz. dependent loss) | (dB) | 0.1 | 0.1 |
| Return Loss | (dB) | 40 | 40 |

The table shows that the insertion loss (IL) of the WDM module is significantly higher than the sum of the bare filter losses, which is typically 0.5 dB.

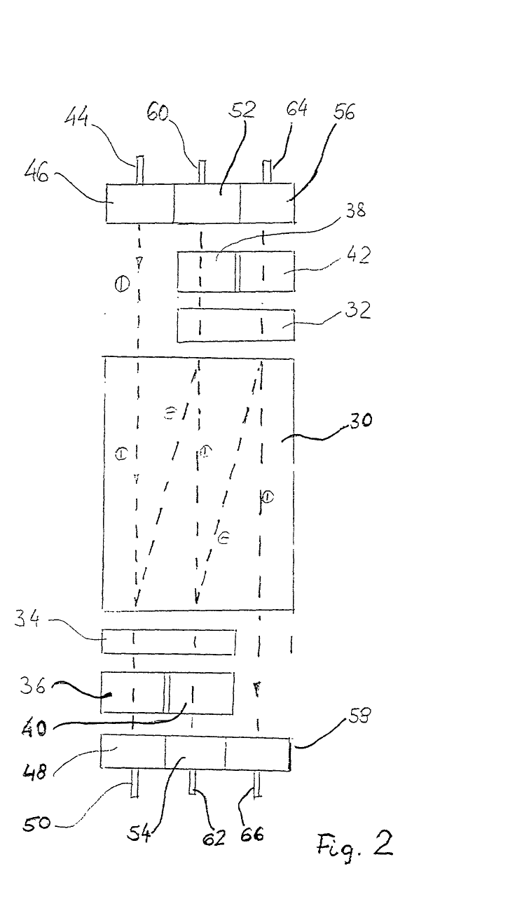

FIG. 2 illustrates one exemplary embodiment of the device of the invention. Because of the two-way transparency of its components, the device can operate as either a multiplexer or as a demultiplexer (with the understanding that practically, multiplexers and demultiplexers have different optical specifications). The demultiplexing functionality will be described here in detail, and those skilled in the art will readily understand the correlated multiplexing function.

The device has a routing block exemplified by a birefringent crystal, so-called rutile crystal 30. A quarter-wave plate (QWP) 32 is disposed on the upper face (as illustrated) of the crystal 30, and another QWP 34 is disposed on the opposite, lower face of the crystal 30. Four different TFFs 36, 38, 40 and 42, selected to filter predetermined wavelengths, are secured adjacent to the QWPs and arrayed in a zig-zag pattern at the opposite faces of the crystal 30. While the TFFs are represented herein in a simplified manner, it is understood that they usually include a suitable substrate on which a predetermined, wavelength-selective thin film structure is applied.

Optical fiber 44, carrying an incoming multi-channel polarized optical signal 45, communicates with a collimating lens, typically a GRIN lens 46. The lens 46 couples the collimated signal to the crystal 30 through an air gap, as the QWP 32 does not extend over the path of the signal 45. The signal, with “ordinary” polarization (indicated in the drawing as “vertical” polarization), passes through the block 30, through a QWP 34 and onto the first TFF 36 that is selected to pass wavelength λ₁ and reflect the remaining part of the signal. The λ₁ light beam exits the device through a GRIN lens 48 and a fiber 50. The remaining reflected signal is folded and passes back through the QWP 34 into the block 30. Due to the double pass through a QWP 34, its polarization changes orthogonally to “extraordinary” polarization (indicated as a “horizontal” polarization). As a result, the reflected signal “walks off” i.e. undergoes an angular deflection which is a function of the refractive index of the crystal 30. Advantageously, the crystal 30 is of a material having a relatively high refractive index, e.g. titanium dioxide (TiO₂) crystal having refractive index of 2.5, corresponding to a beam-shifting angle of about 5.70 at 1550 nm. The optical length of the routing crystal can be in the order of 15 mm.

The QWP can be replaced by a Faraday rotator or any rotator means that enables the beam passing twice there through to undergo a 90° polarization rotation.

As the reflected signal exits the crystal 30, it undergoes another refraction at the upper face of the crystal 30 so that it passes the QWP 32 and hits the filter 38 practically at a normal angle of incidence. The filter transmits a predetermined wavelength and reflects others. The reflected signal, analogously to the previously described scenario, undergoes a change of polarization to ordinary. In all instances, the angle of incidence on the TF filters remains approximately normal (1.8°) while the angles of separation within the block 30 remain relatively high, approx. 6°, which contributes to a size reduction of the device.

As can be seen, the route via filters 36, 38, 40 and 42 defines a zig-zag pattern. In the demultiplexer embodiment illustrated, separate channels with wavelengths λ₁, λ₂, λ₃, λ₄, . . . are passed out of the device through GRIN lenses 48, 52, 54 and 56 and fibers 50, 60, 62 and 64 respectively, while the remaining “degenerate” signal is directed to an “upgrade” port and exits the device (without passing through the QWP 34) through the GRIN lens 58 and fiber 66.

As indicated above, the device as illustrated and described hereinabove may be used as a multiplexer or as an integrated add-drop multiplexer/demultiplexer. The latter functionality will be described later on.

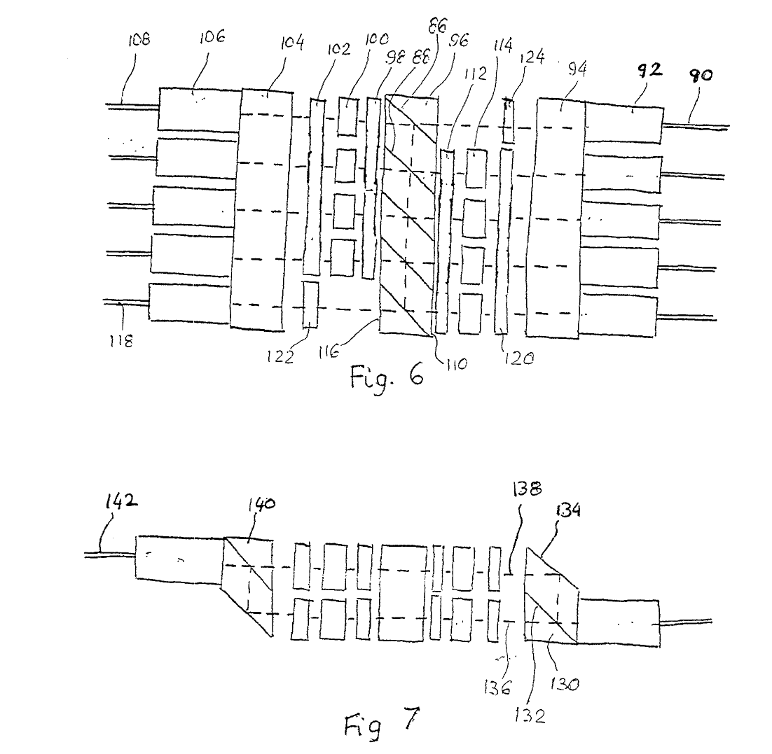

The invention may also be realized by using a polarizing beam splitter instead of a birefringent block as a routing means 30. In such a case, the zig-zag pattern is arranged differently (see FIG. 6) and while the principle of the invention remains, the above-described space-saving arrangement may be compromised.

In the embodiment shown in FIG. 6, the birefringent routing block of FIG. 2 is replaced by an array of polarizing beam splitters formed either by independent polarization beam splitters or formed of a block of glass 96 that includes polarization sensitive surfaces 86, 88 . . . as shown in FIG. 6. The polarization sensitive surfaces 86, 88 . . . are shown at an angle. These surfaces are designed such that a beam that is polarized parallel to the plane of the page will be transmitted while a beam that is polarized perpendicular to the plane of the page will be reflected.

For simplicity, assume an incident beam to be polarized parallel to the plane of the page. The incident multi frequency signal beam emerges from fiber 90, passes through the collimating lens 92, then passes through the polarization diversity crystal 94 (described below) and then enters the optical glass routing block 96. The beam is then incident on the first polarization sensitive surface 86 and passes through it (since the beam is polarized along the plane of the page). When this beam emerges from the second face of the glass block 96, it will go through QWP 98 and then will impinge on TFF 100. This TFF passes wavelength λ₁ and reflects the remaining part of the signal. The selected wavelength will go through QWP 102, the polarization diversity block 104, and then through GRIN lens 106 and enter the first output fiber 108. The signal reflected from TFF 100 will again pass through QWP 98. After emerging from this QWP, the signal beam is now polarized perpendicular to the plane of the page. The beam then reenters the optical block 96 and is again incident on the first polarization sensitive surface 86 but will now be reflected down as illustrated. The beam will then be incident on polarization sensitive interface 88 and will reflect therefrom to the right. The beam will emerge from the optical block 96 at surface 110 and will pass through QWP 112 that will change the polarization state of the beam. The beam will now impinge on TFF 114. This TFF will pass wavelength λ₂ and will reflect the remaining part of the signal. The reflected part of the signal will again pass through QWP 112 but in the opposite direction, leftwards, and after passing the QWP 112 the signal beam will emerge polarized parallel to the plane of the page. The beam will now reenter the optical block 96 through surface 110. The beam will now encounter the polarization sensitive surface 88 and will pass therethrough since the polarization of the beam will be parallel to the page. The beam will emerge from the optical block 96 at surface 116. Next, the beam will encounter the other QWP's and TFF's according to a mechanism described above and will enter and exit the optical block 96 with its polarization changing in a way similar to that described above. Different wavelengths will be selected by the different TFF's. The remaining part of the signal will emerge from the optical block 96 and will be coupled to fiber 118 and out of the device.

The choice of polarization rotators before and after the TFF's is important. For the example discussed above (with input polarization parallel to the page), plates 98, 102, 112 and 120 consists of a QWP at 45°. For this case, plate 122 is a HWP half-wave plate at 45° and plate 124 is absent. However, if the polarization emerging from fiber 90 is perpendicular to the plane of the page, then plates 98 and 112 are QWP at 45° but plates 102 and 120 are now QWP at −45°. Plate 122 is now absent but plate 124 is a HWP (half-wave plate) at 45°.

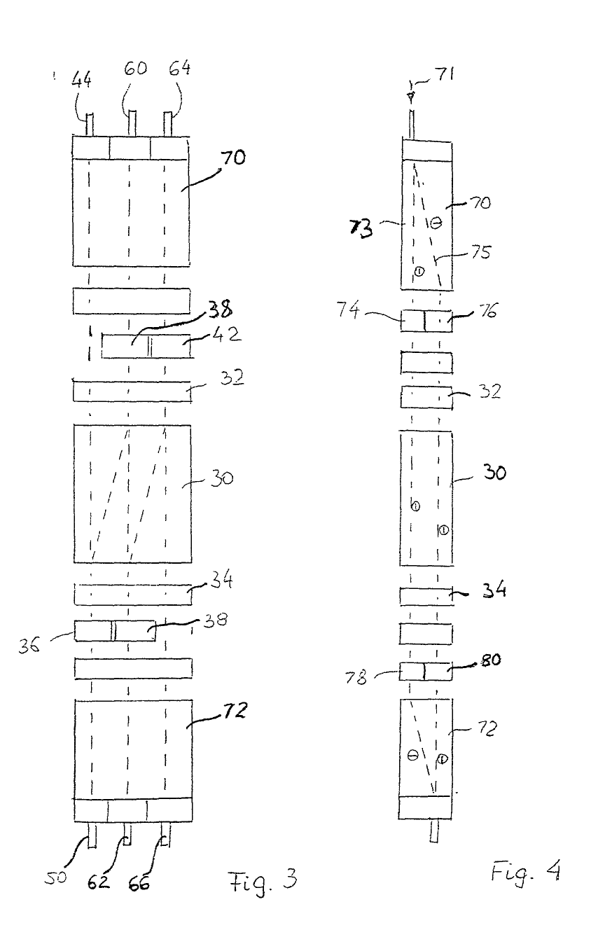

FIGS. 3 and 4 represent an embodiment of the invention wherein the incoming multi-channel optical signal is non-polarized (of so-called “circular polarization”). In this case, it is necessary to control polarization of the incoming signal and the routed beams. This is accomplished by providing polarization diversity means.

In FIG. 3, the device is modified relative to the embodiment of FIG. 2 by the addition of two polarization diversity (PD) blocks, birefringent crystals 70, 72, between the fiber/lens modules and the routing block 30. Another modification is the provision of additional rotator elements exemplified by split quarter wave plates QWP 74, 76 and 78, 80 (better illustrated in FIG. 4) in the optical path between the TF filters and the PD blocks 70, 72 respectively.

The function of the PD blocks and the split QWPs is to separate a non-polarized multi-channel incoming beam of light into two identically polarized sub-beams. The polarizations of the sub-beams, initially orthogonal after passing through the PD block, undergo a modification through rotation of at least one of the sub-beams to result in the sub-beams, with identical polarization, passing through the routing block in a zig-zag fashion between the TFFs analogously to the scenario illustrated in FIG. 2.

Referring now also to FIG. 4, which is a side view of the device of FIG. 3, the birefringent block 70 splits the incoming beam 71 into two sub-beams 73 and 75 having orthogonal polarizations, as marked. QWP 74 is selected to rotate the polarization of the “ordinary” sub-beam 73 in one direction, e.g. −45°. The sub-beam bypasses the filters and passes directly to another QWP 32 which is selected to have an opposite rotation direction, i.e. +45°. Thus, the polarization of sub-beam 73 remains “ordinary” (o) and the sub-beam 73 passes into the routing block 30 to be routed through the subsequent TFFs as described above.

The sub-beam 75 is directed through a separate QWP 76 that has a +45° rotation capability, similarly as the QWP 32. Again, the filters 38, 42 are bypassed. The sum of the two rotations causes the polarization of sub-beam 75 to become “ordinary” and as a result, the sub-beams 73, 75 pass through the block 30 in parallel at two levels as seen in FIG. 4. Following their zig-zag passage and removal of predetermined channels at the filters, the beams 73, 75 undergo a polarization conversion that is the reverse of the one described above. To this effect, QWP 78 is selected to have a 45° rotation of the opposite sign as the QWP 34, while the QWP 80 has a 45° rotation of the same sign as QWP 34. As a result, the sub-beams, having now orthogonal polarization, are recombined in the PD block 72 to retrieve the full power of the incoming beam.

Of course, FIG. 4 illustrates the optical path of just one incoming beam. It is clear that several beams may be processed in the device in the aforementioned manner, either in the multiplexer/demultiplexer mode or add/drop mode of the device. It is the proper selection of the filters and the rotator elements that makes the device function in either mode.

As shown in FIG. 5, the PD blocks 70, 72 of FIG. 4 can be replaced with polarizing beam splitters (PBS) 82, 84 equipped with mirrors. The split QWPs 74, 76, 78 and 80 are shown also in FIG. 5, while the other elements are omitted for clarity. It will be easily understood by those skilled in the art that that the operation of the embodiment of FIG. 5 is analogous to that of FIGS. 3 and 4.

FIG. 7 illustrates the operation of the embodiment of FIG. 5. The unpolarized input beam enters the polarization diversity element 130 as shown and the beam encounters a polarization beam splitter surface 132. Light that is parallel to the plane of the page will be transmitted but light that is polarized perpendicular to the plane of the page will be reflected as shown. The light that is polarized perpendicular to the page will be reflected again by surface 134 and will emerge with a propagation direction parallel to that of the other beam. Both beams 136, 138 will then emerge from the polarization diversity device. After the beams emerge from the polarization diversity device then one of them (the one that is polarized parallel to the page) will pass through a combination of wave plates (rotating means) and will emerge with a polarization perpendicular to the page, like the other beam. The two beams will now enter the optical routing block 30 or 96 described before. In this way, the polarization diversity device processes an unpolarized input beam before it enters the routing block.

The polarization diversity device functions to couple the selected wavelengths to the output fibers. The two beams that are passed by a filter must be recombined and coupled into the appropriate output fiber so that the full power of the signal is retrieved. When these two beams are transmitted through a filter and polarization rotators, they emerge with the same wavelength but with different polarization and they propagate along distinct paths that are ‘parallel’ to each other. One beam is polarized in the plane of the figure and the other one perpendicular to it. It is the purpose of the polarization diversity block 140 to recombine them again before they are coupled to the fiber. The two beams enter the polarization diversity element and beam 138 will be transmitted undeviated as shown in FIG. 7 because of its polarization. Beam 136, on the other hand, will be reflected at both surfaces of the PD block 140 as shown. The two beams will emerge from the block 140 propagating collinearly but with different polarization. They will then be transmitted through a lens and coupled into the output optical fiber 142.

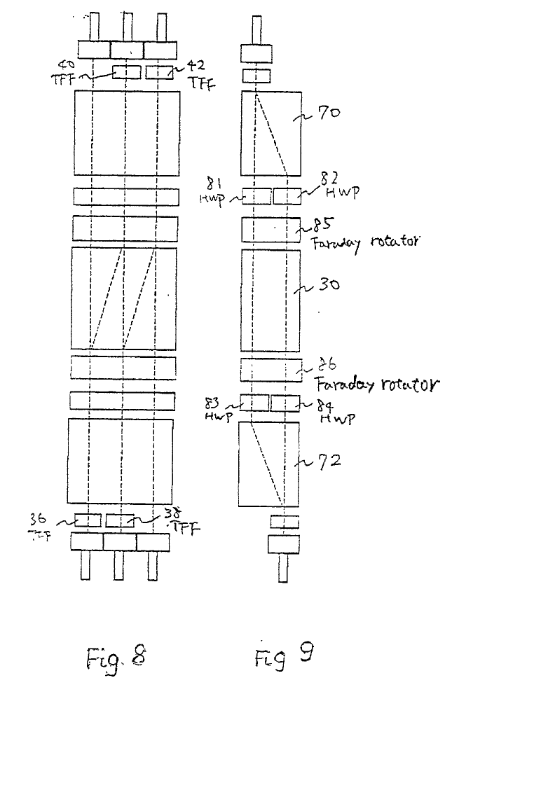

FIGS. 8 and 9 represent another embodiment of the invention wherein the routing of the optical signal is realized by controlling the polarization of the incoming signal by the combination of half-wave plates (HWPs) and Faraday rotators instead of QWPs. The split HWPs 81, 82, 83, and 84 are oriented in such a way that a pair of beams that is propagating through them experiences an opposite rotation of polarization by ±45°. Each of Faraday rotators 85 and 86 provide a uniform rotation of polarization by 45° for a pair of beams that goes through it. In this case, due to the non-reciprocity of the Faraday rotators, TFFs 36, 38, 40, and 42 may be placed outside of the birefringent crystals 70 and 72.

Numerous other embodiments of the invention are feasible without departing from the spirit and scope of the invention. For instance, in order to accommodate a specific polarization of the incoming signal, it is possible to provide for a rotation of the routing block e.g. by 90° instead of rotating the polarization of the respective beam.

What is claimed is:

1. An optical filtering device comprising:
a routing block having an input port, for directing a polarized light beam launched into the input port along a first path, in one of two directions in dependence upon the polarization state of the polarized light beam,
an optical filter element for filtering a characteristic of the beam, the filter being optically coupled with the routing block for allowing a first portion of the polarized beam launched into said routing block to pass through said filter and for reflecting a second portion of the beam back to the routing block to follow a second path, and
a rotator for rotating the polarization of the second portion of the beam so that it follows the second path after reflection from the optical filter element.

2. The device of claim 1 wherein the routing block comprises a birefringent material.

3. The device of claim 1 wherein the routing block comprises a polarizing beam splitter.

4. The device of claim 1 wherein said optical filter element is a wavelength dependent filter element for passing at least one wavelength of light and for reflecting a different wavelength of light.

5. The device of claim 4 wherein said optical filter element is a dichroic filter.

6. The device of claim 1 comprising a plurality of optical filter elements arranged at or about end face or faces of the routing block in a manner to define a zig-zag path for the polarized input beam when reflected from the plurality of the optical filter elements. 7. The device of claim 6 wherein the zig-zag path is a uniform path.

8. An optical filtering device which comprises:
a polarization diversity means for splitting an incoming beam of light into two orthogonally polarized sub-beams and for rotating the polarization state of at least one of the polarized sub-beams to provide two sub-beams having a same polarization orientation,
a routing block having an input port, for directing a polarized light beam launched into the input port along a first path, in one of two directions in dependence upon the polarization state of the polarized light beam,
an optical filter element for filtering a characteristic of the beam, the filter being optically coupled with the routing block for allowing a first portion of the polarized beam launched into said routing block to pass through said filter and for reflecting a second portion of the beam back to the routing block to follow a second path, and
a rotator for rotating the polarization of the second portion of the beam so that it follows the second path after reflection from the optical filter element.

9. The device of claim 8 wherein said polarization diversity means comprises a birefringent crystal.

10. The device of claim 8 wherein said polarization diversity means comprises a polarizing beam splitter.

11. The device of claim 8 wherein said polarization diversity means comprises a second rotator for rotating the polarization state of at least one of the polarized sub-beams.

12. The device of claim 11 wherein said rotator and said second rotator are quarter waveplates.

13. The device of claim 1 wherein said rotator is a quarter waveplate.

14. The device of claim 1 wherein said rotator is a Faraday rotator.

15. A method of routing a polarized optical signal beam comprising
launching the polarized optical signal beam into a birefringent block having a first end face and a second end face,
reflecting the signal beam alternatively at the first and the second end face to effect a plurality of reflections,
rotating the polarization of the signal beam at at least some of the reflections to effect an angular displacement of the signal beam in the birefringent block upon reflection of the beam,
whereby the signal beam is routed along a zig-zag path through the birefringent block.

16. The method of claim 15 wherein the reflecting is effected using at least one reflective surface at one of the end faces of the birefringent block.

17. The method of claim 15 wherein the reflecting is effected using a plurality of reflective filters arranged at the first and second end face of the birefringent block.

18. The method of claim 17 wherein the reflective filters are thin film filters selected to filter predetermined channels out of the optical signal beam.
